(19) United States
(12) Patent Application Publication
(10) Pub. No.: US 2026/0192615 A1
(43) Pub. Date: Jul. 9, 2026

(54) HITCH RECEIVER AND COUPLING TONGUE FOR HEAVY DUTY APPLICATIONS

(71) Applicant: Vernon William SPARKES, Cayley (CA)

(72) Inventor: Vernon William SPARKES, Cayley (CA)

(21) Appl. No.: 19/133,168

(22) PCT Filed: Nov. 28, 2023
(86) PCT No.: PCT/CA2023/051592

§ 371 Date: May 27, 2025

Related U.S. Application Data
(60) Provisional application No. 63/385,283, filed on Nov. 29, 2022.

(51) Int. Cl. B60D 1/02; B60D 1/58

(52) U.S. Cl. CPC B60D 1/02; B60D 1/58

(57) ABSTRACT

A heavy duty hitch receiver having a coupling pin passageway for coupling the receiver to a coupling tongue that is inserted into the socket of the receiver. The coupling pin passageway in the receiver has a socket section and a section that is external to the socket. At least one extender extends outwardly from the socket and provides the section of the coupling pin passageway that is external to the socket. The socket may further comprise a protrusion that mates with a keyway in the coupling tongue. The heavy duty hitch receiver frustrates the ability of an end user to use a hitch assembly in the receiver if the hitch assembly is not designed for use with the receiver.

### CROSS-REFERENCE TO RELATED APPLICATION

This application claims the benefit under 35 U.S.C. 119(e) of U.S. Provisional Application 63/385,283, filed Nov. 29, 2022, and incorporated herein by reference in its entirety.

### FIELD

The present disclosure relates to the field of apparatuses for use in the recovery of vehicles. It particularly relates to a hitch receiver and coupling tongue that are designed to impede the use of a smaller-than-designed-for hitch assembly therein.

### BACKGROUND

During the course of operating a vehicle, it may be necessary to recover the vehicle for one reason or another, for example if the vehicle were to slide off a road into a ditch, to get stuck in mud or snow or any number of other types of terrain (i.e., as with an agricultural tractor or other heavy machinery). In these situations, it is desirable to have a means of safely dislodging the vehicle if it is stuck and possibly also towing it to a desired location (i.e., to a garage, back onto the road, etc.).

U.S. Pat. No. 7,871,097 to Sparkes describes a pivoting hitch assembly that is particularly suitable for connecting a tow strap or belt to a commercially available tubular trailer hitch receiver, for use in towing operations. This hitch assembly is strong and sturdy, safe, easy to use and lightweight and has successfully solved problems with prior art devices relating to the breaking or snapping of towing apparatuses, especially when they experience a shock load/impact load. FIG. 1, which is prior art, shows this pivoting hitch assembly, that comprises a tongue with an opening for coupling the hitch assembly to a tubular hitch receiver on a vehicle with a coupling pin, a clevis for accommodating a tow strap, and a hitch pin for pivotally connecting the clevis to the tongue.

The pivoting hitch assembly of U.S. Pat. No. 7,871,097 may be used with a conventional tubular hitch receiver. However, when it is desirable to tow or recover an extremely heavy load using this pivoting hitch assembly, a larger and stronger hitch assembly with a higher tow weight rating may need to be used.

The coupling tongue of the hitch assembly must therefore also be larger and stronger, requiring use of a larger tubular hitch receiver, as part of an overall larger and stronger hitch. However, if a larger tubular receiver is installed on a vehicle, the risk remains that end users will insert the coupling tongue of a smaller hitch assembly into the larger receiver and attempt to pull the large load with the smaller hitch assembly. If the smaller hitch assembly is not rated for pulling the large load, the hitch assembly can break when pulling forces are applied, with the result that the hitch assembly becomes projectile with the potential to damage property and/or injure persons nearby.

Because of the risks involved and the potential for liability, many companies prohibit their employees from even attempting to recover or tow a vehicle that is stuck or that has broken down. However, with the design of safer and better towing systems, such as that described above in U.S. Pat. No. 7,871,097, companies are beginning to allow employees to attempt to perform these operations.

Although a company may prohibit the use of a smaller or weaker hitch assembly in a larger receiver, this may not be sufficient to discourage employees from doing so, particularly when they are in a remote location and assistance is far away. It would be desirable, therefore, to have a means of preventing employees from using a smaller hitch assembly in a larger receiver, regardless of the circumstances.

There is therefore a need in the art for an apparatus and method that prevents end users from inserting a small hitch assembly into larger receiver that was not designed for use with this small hitch assembly, in order to tow or recover a large load.

Further and other objects will become readily apparent to one skilled in the art when considering the summary below and the more detailed description of the preferred embodiments shown and described herein.

### BRIEF DESCRIPTION OF THE DRAWINGS

FIG. 1 is a perspective view of a prior art pivoting hitch assembly.

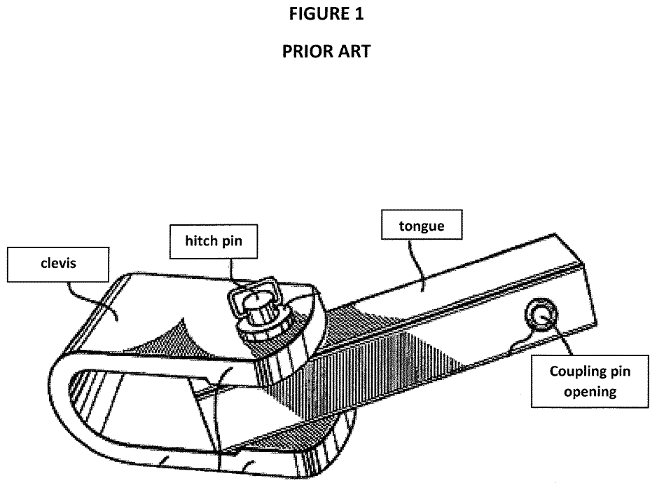

FIG. 2 is a schematic drawing showing the features of the heavy duty hitch receiver described herein.

FIG. 3A-C are perspective views of embodiments of the wall extenders described herein.

FIG. 4 is a perspective view of an embodiment of the heavy duty hitch receiver.

FIG. 5 is an end view of the hitch receiver of FIG. 4.

FIGS. 6A and B are cross-sections through two embodiments of the heavy duty hitch receiver.

FIG. 7A is front view of an embodiment of a heavy duty hitch receiver comprising a protrusion, according to some embodiments of the present disclosure; FIG. 7B is a view of the socket of the heavy duty receiver of FIG. 7A; and FIG. 7C is a side view of the heavy duty hitch receiver shown in FIG. 7A.

FIG. 8 is atop view of an exemplary embodiment of a coupling tongue of the present disclosure comprising a keyway.

FIG. 9 is a side perspective view of an embodiment of a hitch assembly disclosed herein.

FIG. 10 is a side perspective view of another embodiment of a hitch assembly disclosed herein.

FIG. 11 is top elevation view of the hitch assembly of FIG. 10.

### SUMMARY

In one aspect, disclosed is a heavy duty hitch receiver having a coupling pin passageway for coupling the receiver to a coupling tongue with a coupling pin, the coupling pin passageway having a length and comprising a socket section and a section external to the socket, the receiver comprising:
a) a socket sized to receive the coupling tongue therein;
b) first and second axially aligned socket openings in opposing walls of the socket, the first and second openings sized for insertion of the coupling pin therethrough;
c) a first extender extending outwardly from the socket and comprising a first extender opening spaced apart a distance from, and in axial alignment with, the first socket opening, the first extender opening sized for insertion of the coupling pin therethrough;
   wherein the first and second openings provide the socket section of the coupling pin passageway, and
   wherein the first socket opening and the first extender opening provide the section of the coupling pin passageway external to the socket.

In embodiments the receiver further comprises a second extender extending outwardly from the socket, the second extender comprising a second extender opening spaced apart a distance from, and in axial alignment with, the second socket opening, the second extender opening sized for insertion of the coupling pin therethrough; wherein the second socket opening and the second extender opening provide an additional section of the coupling pin passageway external to the socket.

In embodiments the socket is a tubular socket having a socket wall of constant thickness around the socket, and the first extender and/or the second extender is attached to an outer surface of the socket wall.

In embodiments the socket section comprises 70% or less of the length of the coupling pin passageway.

In embodiments the socket is square or rectangular in cross section.

In embodiments the receiver further comprises at least one protrusion protruding into the socket.

In embodiments the at least one protrusion is positioned on a top inner surface or on a bottom inner surface of the socket.

In another aspect disclosed is a heavy duty hitch receiver comprising a coupling pin passageway having a length:
a) a tubular socket having a top wall, a bottom wall, a first side wall and a second side wall, each wall having an inner surface and an outer surface;
b) axially-aligned openings in the first side wall and the second side wall, respectively, providing a socket section of the coupling pin passageway therebetween;
c) a first extender disposed on the outer surface of the first side wall, said first extender having a first extender opening in axial alignment with the opening in the first side wall,
d) the first extender providing a first extender section of the coupling pin passageway in axial alignment with the socket section of the coupling pin passageway and increasing the length of the coupling pin passageway by a distance between the opening in the first side wall and the first extender opening.

In embodiments the receiver further comprises a second extender disposed on the outer surface of the second side wall:
a) the second extender having a second extender opening in axial alignment with the opening in the second side wall; and
b) the second extender providing a second extender section of the coupling pin passageway in axial alignment with the socket section of the coupling pin passageway and increasing the length of the coupling pin passageway by a distance between the opening in the second side wall and the second extender opening.

In embodiments the walls of the tubular socket provide a square socket in cross section.

In embodiments the socket section of the coupling pin passageway comprises 70% or less of the length of the coupling pin passageway.

In embodiments the receiver further comprises at least one protrusion protruding into the socket.

In embodiments the at least one protrusion is positioned on a top inner surface or on bottom inner surface of the socket.

In another aspect disclosed is a coupling tongue comprising:
a) a first end;
b) a second end;
c) a top;
d) a bottom;
e) two sides;
f) a first aperture sized to engage a coupling pin at the first end, the first aperture extending between the two sides;
g) a second aperture sized to engage a hitch pin at the second end, the second aperture extending between the top and the bottom of the coupling tongue; and
h) at least one keyway extending along at least a portion of an external surface of the coupling tongue from the first end toward the second end, the at least one keyway sized and configured for receiving a protrusion.

In another aspect disclosed is a towing assembly comprising:
a) a heavy duty hitch receiver according to any one of preceding embodiments; and
b) a coupling tongue as described above.

### DETAILED DESCRIPTION

Described herein is a heavy duty hitch receiver that is designed to prevent, or at least make it significantly more difficult, for end users of the receiver to couple a hitch assembly to the receiver if the hitch assembly is inferior, smaller or weaker than the hitch assembly for which the receiver is designed.

Prior art known receivers typically comprise a receiver tube section that is securely attached to the frame of a vehicle. A tongue is slipped into the socket of the receiver tube and secured in place with a coupling pin. In these conventional receivers, the coupling pin is only as long as the socket of the receiver. The tongue can be connected to any of a number of devices, such as a ball-mount, a tow hook or clevis, or it may be part of a utility carrier for bikes, skis, cargo etc. Receiver tubes are generally sized slightly larger than necessary to allow the tongue to be easily installed or removed, and they are typically square.

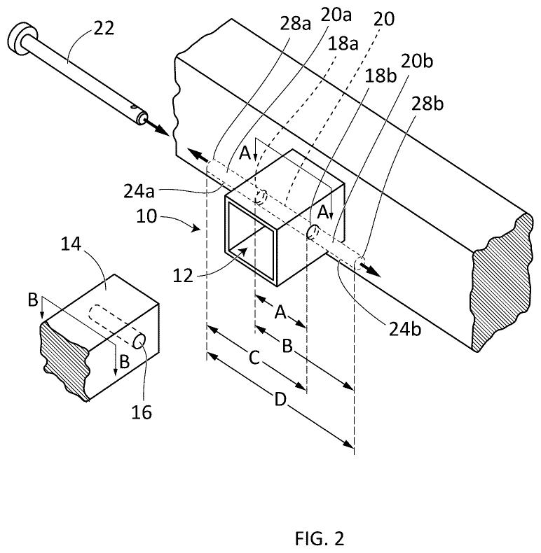

FIG. 2 shows a schematic of the heavy duty hitch receiver, referred to herein by the general reference numeral 10. The receiver 10 has a top, a bottom and two sides, with an opening on each side. A coupling pin 22 is inserted through the receiver along a coupling pin passageway that extends from the opening on one side to the opening on the other side. The receiver may be attached, as by welding or bolting, to conventional frames or mounting brackets which are configured to be mounted to the underside of a vehicle, or onto the front or back of a vehicle, such as to a chassis/frame/belly pad/engine housing etc. of the vehicle. The frame mounting brackets may include one or more openings formed therein to facilitate attachment of the frame mounting brackets to the vehicle.

Heavy duty receiver 10 comprises a socket 12 for receiving a tongue (hitch shank) 14. The socket 12 is sized to allow tongue 14 to be easily installed or removed. Socket 12 holds tongue 14 securely within the heavy duty receiver, and in a preferred embodiment socket 12 is formed by a tubular sleeve, such as a conventional receiver tube known in the art. Or, socket 12 may be formed as an integral part of the heavy duty receiver, as described below. Socket 12 surrounds and extends along a length of tongue 14, in close relationship therewith to minimize vertical, horizontal and in preferred embodiments, rotational movement of the tongue 14 when it is disposed therein.

In a preferred embodiment socket 12 is rectangular, and more preferably, square, in cross-section when viewed along the A-A plane (FIG. 2). However, it may be any of a number of other shapes in cross section, such as any other polygon, or circular or oval. Socket 12 preferably has four socket walls (30, 31a,b and 32), with each adjacent pair of walls being perpendicular to one another, and opposite walls being parallel to one another. Other arrangements and shapes may be possible, but the preferred arrangement is typical and most commonly used in the hitch industry. Paired axially aligned openings 18a and 18b are in opposing sides of socket 12.

Tongue 14 has a cross-sectional shape, when viewed along the B-B plane (FIG. 2), that is complementary to the cross-sectional shape of the socket. Tongue 14 is inserted into socket 12 until tongue opening 16 aligns with paired axially aligned socket openings 18a and 18b, so that coupling pin 22 can be inserted through aligned openings 16, 18a and 18b, to operably secure the tongue in the socket and to the hitch receiver. By “operably secure” it is meant that the coupling tongue 14 is inserted into the socket 12 and connected thereto by insertion of a coupling pin 22, through tongue opening 16 and both openings 18a, 18b, of the opposing socket walls.

Coupling pin 22 has a first end and a second end. As depicted in the embodiments herein it is of a cylindrical or round shape in cross section. It may also be of a cross-sectional shape that is oval, or any polygon. It may have an annular ring pressed onto the pin at the first end to aid in the positioning of the pin for insertion through openings 16 and 18a,b. The coupling pin is held in the openings by use of retainer such as a locking clip or ring, as is well known in the art.

Coupling pin 22 may be made of a tough metal alloy such as steel that can be of varying strengths. For some applications, the coupling pin may be made of AISI 4140 beat treated carbon and alloy steel bar, or hot rolled steel. It may be coated with a corrosion resistant material, for example zinc oxide or cadmium, or galvanized.

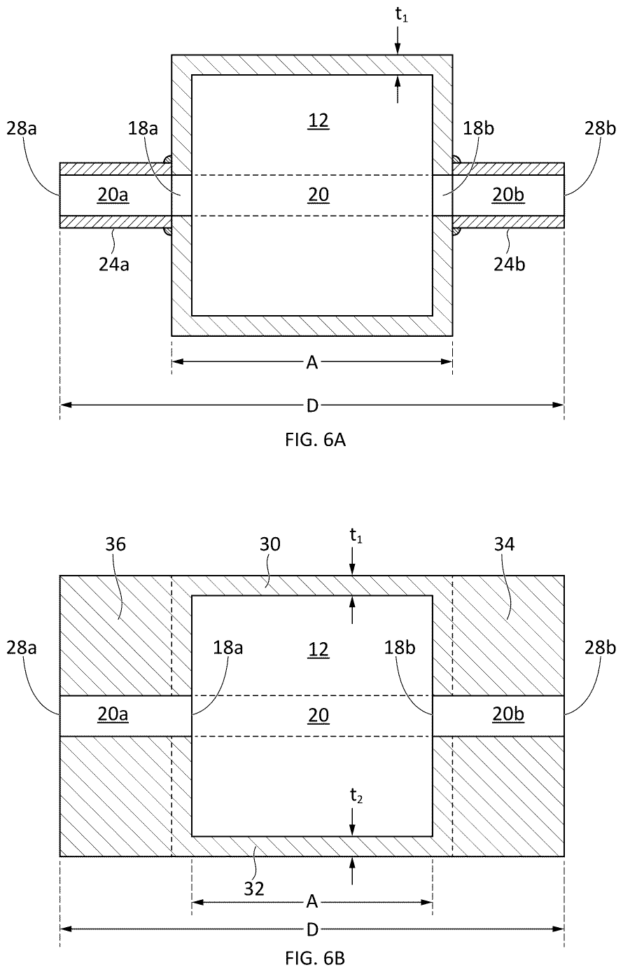

Paired axially aligned openings 18a and 18b are in opposing walls of socket 12 and between them define a coupling pin passageway 20 in the socket, through which coupling pin 22 extends when inserted to operably secure the tongue 14 in the socket 12 (see FIG. 2 or 6). The coupling pin passageway is where the coupling pin 22 will be situated when the tongue is operably secured in the socket.

If socket 12 is a tubular socket formed from sheet metal stock bent into the appropriate shape, the walls of the socket would have an approximately constant thickness all the way around the socket. Socket openings 18a and 18b are formed in opposing walls of the socket. Thus, the length of passageway 20 is the distance across the socket from opening 18a to 18b plus the wall thickness on either side of the socket (distance A), which distance approximates the minimum length of the coupling pin 22 for use therein.

The heavy duty hitch receiver 10 described herein increases the length of the coupling pin passageway in the receiver, as compared to known receivers. To this end, the receiver further comprises, on at least one side of the socket 12 an extender 24, extending outwards from the socket. “Outward” or “outwardly” as used herein means away from the socket.

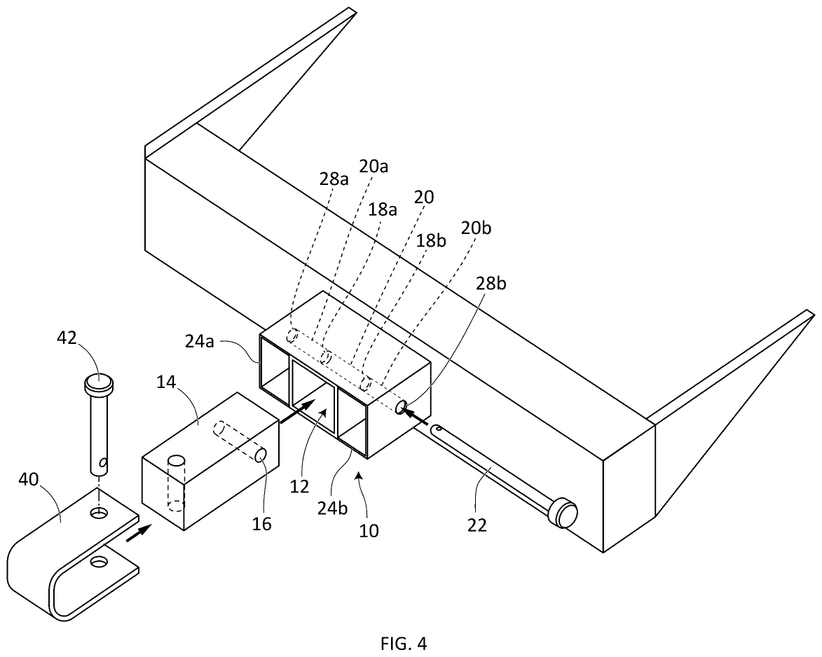

The at least one extender 24 comprises an extender opening 28a or 28b, that is axially aligned with and spaced a distance outwards from socket opening 18a or 18b, respectively. Paired openings 18a and 28a, and paired openings 18b and 28b (see FIG. 2 or 4), form coupling pin passageways 20a and 20b, respectively. These coupling pin passageways 20a and 20b are external to socket 12 and are in axial alignment with passageway 20 in the socket. The extender 24 therefore increases the length of the coupling pin passageway in the receiver 10, by the distance between openings 18a and 26a and/or openings 18b and 26b, that is, by the length of passageway 20a and/or 20b, as the case may be.

In the heavy duty hitch receiver 10, the length of the coupling pin passageway 20 is determined not only by the distance between socket openings 18a, 18b, but also by the distance between socket openings 18a and/or 18b and extender openings 28a and/or 28b. Therefore, the length of the coupling pin passageway in the heavy duty hitch receiver 10 is the length of the passageway within the socket 12 plus the length of the at least one passageway that is provided by the extender, external to the socket.

As mentioned above, a conventional receiver is formed from sheet metal stock that is bent into the appropriate shape, most commonly a square shape. In the case of a conventional receiver socket, therefore, the socket wall has a constant thickness, t₁, around the periphery of the socket. The length of coupling pin passageway 20 across this conventional receiver would be distance A (see FIG. 6A). In the embodiment of the heavy duty receiver 10 shown in FIG. 6A, extenders 24a and 24b move the openings to the socket outwards from the socket walls 31a, b, to openings 28a or 28b of the extenders, respectively. The length of coupling pin passageway across this embodiment of the receiver is distance D—the distance between openings 28a and 28b. The distance that coupling pin 22 must therefore traverse, in order to operably secure the tongue 14 in the hitch 10, is thus increased to distance D.

In an embodiment, shown in FIG. 6B, heavy duty receiver 10 is formed as a unitary construct around the socket 12, for example from a die by injection moulding. A receiver 10 formed by this method may not be tubular with a constant thickness, t₁, of the walls around the periphery of the socket. In this case, the top 30 and bottom 32 socket walls may have a thickness of t₁ and t₂, respectively, and these thicknesses may be the same (t₁=t₂) or different (t₁≠t₂). In these receivers 10 the socket walls 34, 36, of the heavy duty receiver function as the extenders 24, moving the openings into the socket outwards a distance, to opening 28a or 28b, and increasing the length of the coupling pin passageway by the thickness of walls 34 or 36. The length of passageway 20 across this embodiment of the receiver is distance D, which is the distance that coupling pin 22 must therefore traverse, in order to operably secure a tongue 14 in the hitch 10. This distance is thus increased, as compared to a receiver that is square in cross section (see dashed lines in FIG. 6B). In this embodiment, the walls 34, 36, on either side of the socket 12 have a thickness that is greater than t₁ and/or t₂, such that the receiver is not square in cross section.

One or two extenders 24 may be used. Having reference to FIG. 2, if one extender 24b is used, it will increase the length of the coupling pin passageway in the receiver by the length of passageway 20b. The distance that the coupling pin 22 must traverse is distance B, the distance between opening 18a and opening 28b. Or, if one extender 24a is used, the length of the coupling pin passageway in the receiver is increased by the length of passageway 20a, and the increased distance is distance C, between opening 18b and opening 28a. If two extenders 24a and 24b are used, they will increase the length of the coupling pin passageway by the length of passageways 20a and 20b. The distance that the coupling pin 22 must traverse is increased to the distance D between openings 28a and 28b. If two extenders are used, they need not be the same length.

The one or two extenders 24 increase the length of the coupling pin passageway 20, that is, the distance between the axially aligned openings on opposing sides of socket 12, as compared to a conventional tubular receiver sized to accept the same-sized tongue 14. In order to couple the receiver 10 and tongue 14 together in the heavy duty receiver described herein, the coupling pin 22 used must be at least long enough to extend across the greater distance B, C or D.

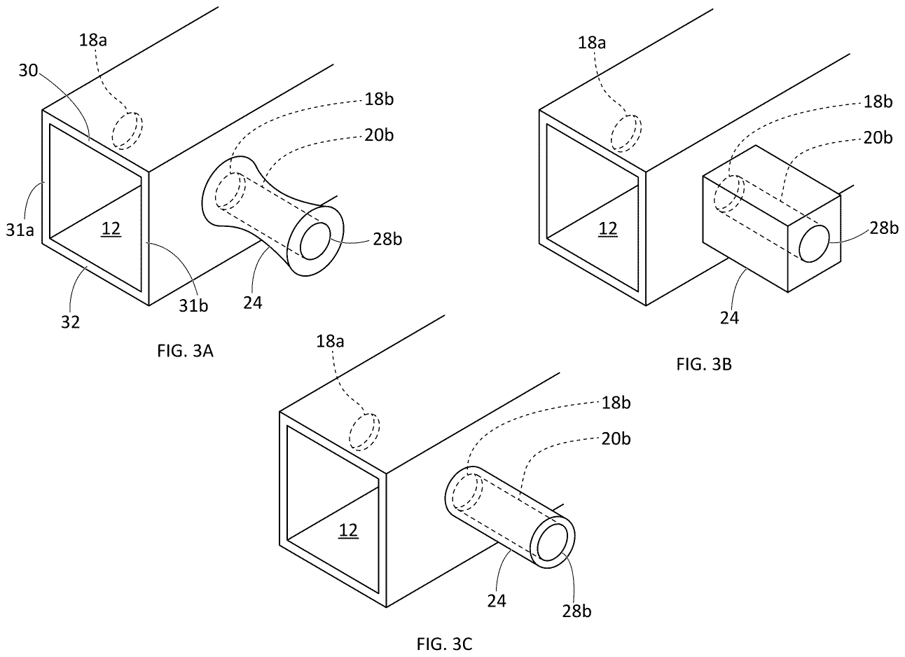

Various embodiments of the extenders 24 are contemplated herein. For example, they may be configured as bosses, that is, solid cylindrical projections around the openings 18a,b (see FIG. 3A); solid square blocks around the openings 18a,b (see FIG. 3B) or hollow tubulars around the openings 18a,b (see FIG. 3C). The extenders 24 may be connected to the outside of a socket wall e.g., formed by a tubular receiver, as by welding, or they may be formed as a unitary construct around a socket, for example from a die by injection moulding.

It is further contemplated that a tube may be inserted through the openings of the receiver to function as a guide for the insertion of the coupling pin—thus the coupling pin is inserted through the tube, rather than directly through the openings.

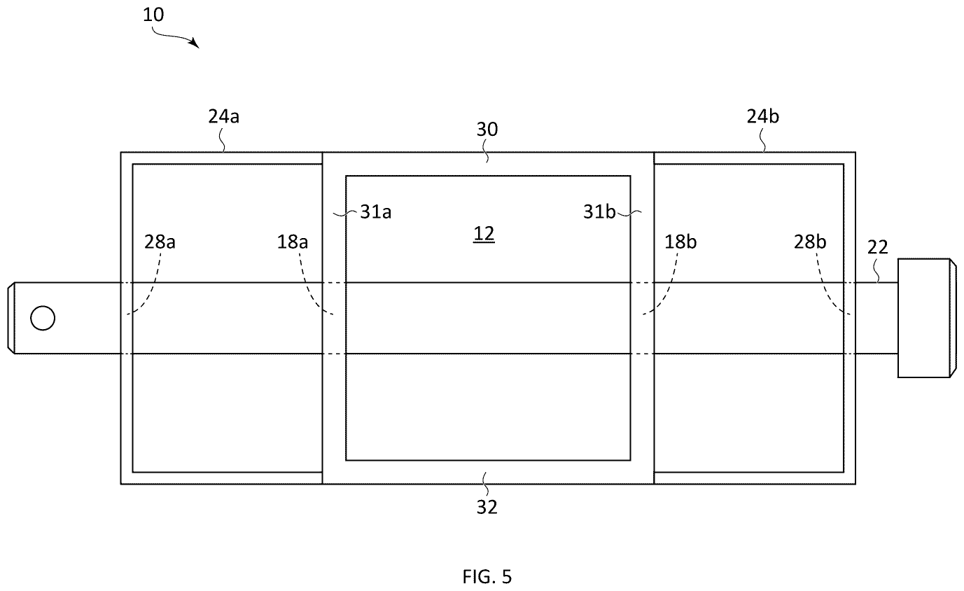

Reference will now be made to FIGS. 4 and 5, which show another embodiment of the hitch receiver described herein.

FIG. 4 illustrates an embodiment of the heavy duty receiver 10, comprising a square socket 12 for receiving a square tongue 14. Tongue 14 is inserted into socket 12 until opening 16 aligns with openings 18a,b of the socket, and coupling pin 22 can be inserted through these openings. In this embodiment, socket 12 is about 3 by 3 inch square and is in the form of a tubular receiver. In other embodiments, the socket 12 may be any size, including about 2×2 inches, about 1.25×1.25 inches, about 4×4″. This Figure also shows a clevis 40 for pivotal attachment to the tongue by a clevis pin 42. However, the coupling tongue 14 may be attached to any suitable member such as, for example, a ball mount (for example, a tow ball or trailer ball), a tow hook, a pintle hitch, or a shackle.

This embodiment of the heavy duty receiver 10 comprises, on each side wall of the socket 12, an extender 24a, 24b. The extenders each comprise an opening 28a or 28b that is axially aligned with socket opening 18a or 18b, respectively, and spaced a distance outwards from the opening 18a or 18b, to form coupling pin passageways 20a and 20b respectively. The extenders thus increase the length of the coupling pin passageway in the receiver by moving the openings to the socket outwards from opening 18a or 18b, to openings 28a or 28b. This increases the distance that a coupling pin must traverse, in order to operably secure a tongue in the socket.

In the embodiment shown in FIG. 4, the extenders are hollow cubes. Each extender 24a,b, extends the length of passageway 20 by moving the opening to the socket outwards from the socket about 2 inches. Thus the increased length of the coupling ping passageway is about 7 inches, and the coupling pin 22 to be used in this embodiment of the heavy duty hitch receiver must be at least about 7 inches long, or longer, as compared to about 3 inches for a conventional hitch without extenders 24a, b. In a particularly preferred embodiment, socket 12 has a size of 2.5×2.5 inches, the walls of the socket are 12 inch thick on each side of the socket, and each of two extenders 24 is 1 inch long. Therefore, the coupling pin passageway in the receiver 10 is a total of 5.5 inches long. A coupling pin for use in this receiver is more than 5.5 inches long, to provide for means to manipulate and position and secure the coupling pin, such as an aperture and locking pin, and annular ring, etc.

In embodiments of the heavy duty receiver 10 described herein, the part or section of the coupling pin passageway that traverses the socket 12 (that is the socket 12 and walls 31a, b) may comprise less than 80%, less than 70%, less than 60%, less than 50%, less than 40% or less than 30% of the total length of the coupling pin passageway in the receiver. In embodiments, the coupling pin passageway of the heavy duty receiver 10 comprises a section that traverses the socket, and a section that is outside of the socket. The section that is outside of the socket may comprise more than 30%, more than 40%, more than 50% or more than 60% or more than 70% or more than 80% of the total length of the coupling pin passageway. In embodiments, the part or section of the coupling pin passageway that traverses the socket 12 (that is the socket 12 and walls 31a, b) may comprise about 80%, about 70%, about 60%, about 50%, about 40%, about 30%, about 50% to about 70%, about 50% to about 60%, or about 60% to about 70% of the total length of the coupling pin passageway in the receiver.

In North America, small tubular hitch receivers are conventionally about 1.25 inches square, and conventional tongues are sized to fit into these receivers. If the coupling pin associated with the smaller receivers is long enough, it may extend through a 3 inch square receiver, and thus may be used to couple the smaller tongue to the 3 inch receiver—for which the tongue is not designed. Alternatively, an end user may have at their disposal a shaft that can be utilized as a coupling pin for the smaller tongue, and that will fit through and extend across a 3 inch square receiver. By increasing the length of the coupling pin passageway in the receiver, such that it is significantly longer than 3 inches, the coupling pin associated with the smaller tongue will not able to extend all the way from opening 28a to opening 28b, to be used therein. Or, a shaft that has sufficient length to function as this longer coupling pin may be more difficult to find.

By extending the length of the passageway in the receiver though which the coupling pin must pass to operably secure the tongue, as described herein, the heavy duty hitch receiver prevents, or at least discourages, end users from using a coupling tongue that is smaller than designed for, in the heavy duty hitch. Thus, the heavy duty hitch will avoid towing and recovery operations that are unsafe.

Heavy duty receiver 10, or parts thereof, may be formed of suitable steel bar stock—for example AISA 1018 steel. But, other metals and materials having sufficient strength and durability, such as aluminum alloy, may be used.

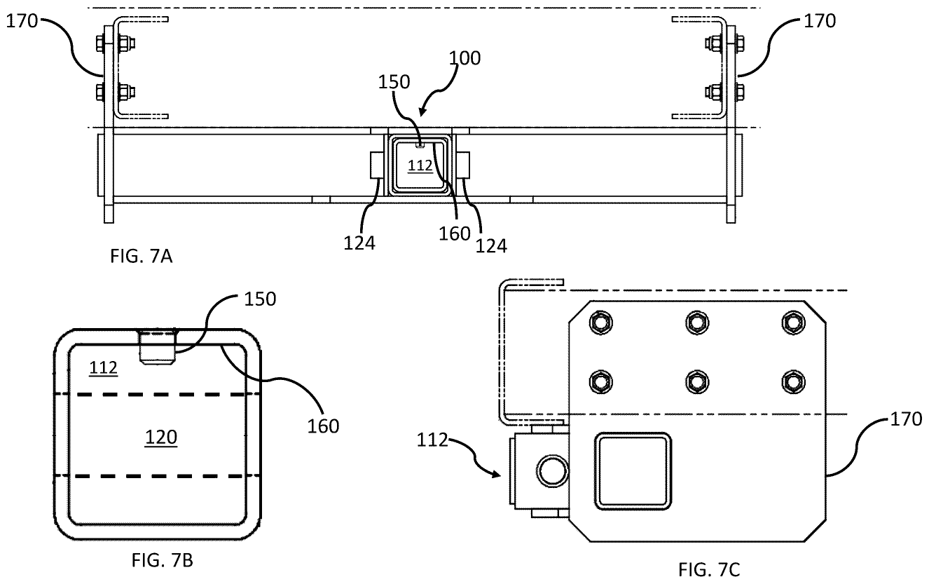

FIG. 7A shows a front view of another exemplary embodiment of a heavy duty hitch receiver 100. The heavy duty receiver 100 is similar to the heavy duty receiver 10 and comprises, on each side of socket 112, an extender 124. In a preferred embodiment, the socket 112 is rectangular, and more preferably, square, in cross-section. However, the socket 112 may be any of a number of other shapes in cross section, such as any other polygon, or circular or oval, as was previously described for the socket 12. Socket 112 preferably includes four walls, each adjacent pair of walls being perpendicular to one another, and opposite walls being parallel to one another. Other arrangements and shapes may be possible, but the preferred arrangement is typical and most commonly used in the hitch industry. The extenders 124 may be any of the extenders 24 described elsewhere herein for extending the length of coupling pin passageway 120 (shown in FIG. 7B) by the length of each passageway (not shown) of the extenders 124. While the embodiment in FIGS. 7A to 7C shows two extenders 124 of a rectangular shape, the receiver 100 may comprise only one extender 124 and/or be of other shapes as previously described.

The pivoting hitch assembly of U.S. Pat. No. 7,871,097 may comprise a conventionally-sized coupling tongue for use with a conventional tubular hitch receiver. However, the materials used to manufacture the hitch assembly of U.S. Pat. No. 7,871,097 provide for a stronger hitch assembly than one that is made with different materials, such as steel only. Therefore, there is a need in the art, when attempting to tow or recover a particularly large load, for a means to prevent an end user from inserting the coupling tongue of a weaker hitch assembly into a heavy duty receiver that is the correct size for the weaker hitch assembly but that is intended to be used with a stronger hitch assembly.

The heavy duty receiver 100 further comprises at least one protrusion 150 protruding into the socket 112, the at least one protrusion 150 sized for being received by at least one keyway in an exterior surface of a coupling tongue when the coupling tongue is received into the socket 112 as described later herein. The at least one protrusion 150 may advantageously function to ensure that only suitable coupling tongues, for example those comprising at least one corresponding keyway, can be inserted into and/or coupled to the socket 112, and may thereby increase the safety of a towing operation.

The at least one protrusion 150 may be positioned at any suitable location on an inner surface defining the socket 112 of the receiver 100 so that a coupling tongue, having one or more corresponding at least one keyway, may be operably received into socket 112. In some embodiments, such as shown in FIGS. 7A and 7B, the at least one protrusion 150 is positioned at a top inner surface 160 (top being the surface that is uppermost when the receiver is attached to a tow vehicle). However, the at least one protrusion 150 may be positioned at a side inner surface, or at a bottom inner surface defining the socket 112. The at least one protrusion 150 may be made of any suitable shape or size for being received by the at least one keyway of a corresponding coupling tongue, without the at least one protrusion 150 entering the passageway 120. In some embodiments, the at least one protrusion 150 may have a square shape, a round shape, or a V-shape. In some embodiments, the at least one protrusion may protrude into the socket 112 about 1/32 inch, about 1/16 inch, about, ⅛ inch, or about ¼ inch from the inner surface 160.

In some embodiments, the at least one protrusion is at least two protrusions. In these embodiments, each protrusion of the at least two protrusions may be on the same side of the inner surface or on different sides of the inner surface and may be of the same size and shape or of a different size and shape.

The at least one protrusion 150 may be a separate component that is attached to the inner surface, for example by welding or gluing, may be a separate component that is removably coupled to the inner surface, for example by screwing into the inner surface, may be inserted though the socket wall, or may be formed as a unitary construct of the receiver 100, for example from a die by injection moulding. In some embodiments, the at least one protrusion 150 may be a pin, a screw, or a welded stud. In some embodiments, the at least on protrusion 150 may be removable from the receiver 100. The at least one protrusion 150 may be of any suitable material having suitable durability. Non-limiting examples of materials for the at least one protrusion 150 include steel, aluminum alloy, carbon and aluminum alloy, or plastic of sufficient durability. In an embodiment, the at least one protrusion 150 is made of AISA 1018 steel. In some embodiments, the at least one protrusion 150 may be coated with a corrosion resistant material, for example zinc oxide.

FIG. 7C shows a side view of the heavy duty hitch receiver 100 shown in FIG. 7A. The heavy duty receiver 100 may be coupled to the frame of a vehicle using plates 170. The plates 170 may be any suitable plate as is known in the art.

The present disclosure also relates to a coupling tongue comprising at least one keyway extending along at least a portion of an external surface of the coupling tongue, the at least one keyway sized for receiving a respective protrusion of the at least one protrusion of a heavy duty hitch receiver described herein. As used herein, the expression “for receiving a protrusion” refers to a respective keyway of the at least one keyway aligning with a respective protrusion of the at least one protrusion in such a manner that the coupling tongue can be inserted into the heavy duty hitch receiver to operatively couple or attach to the hitch receiver as further described below.

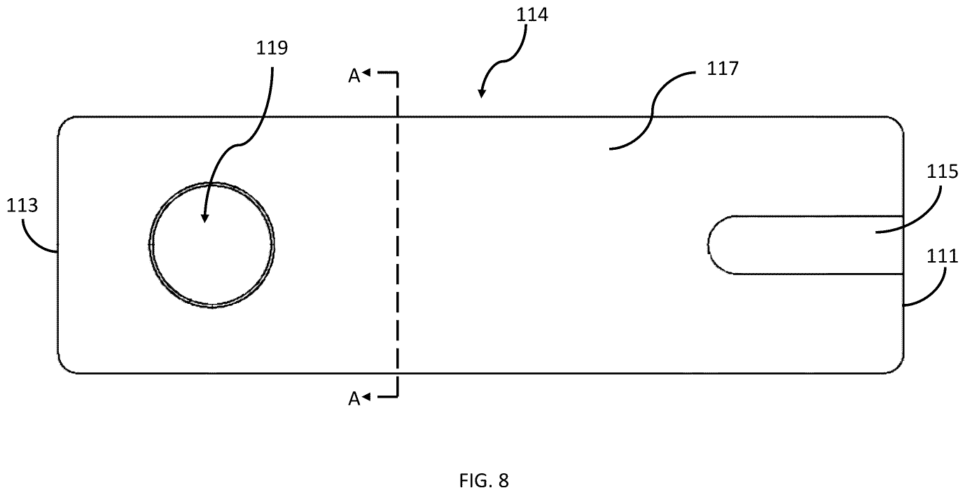

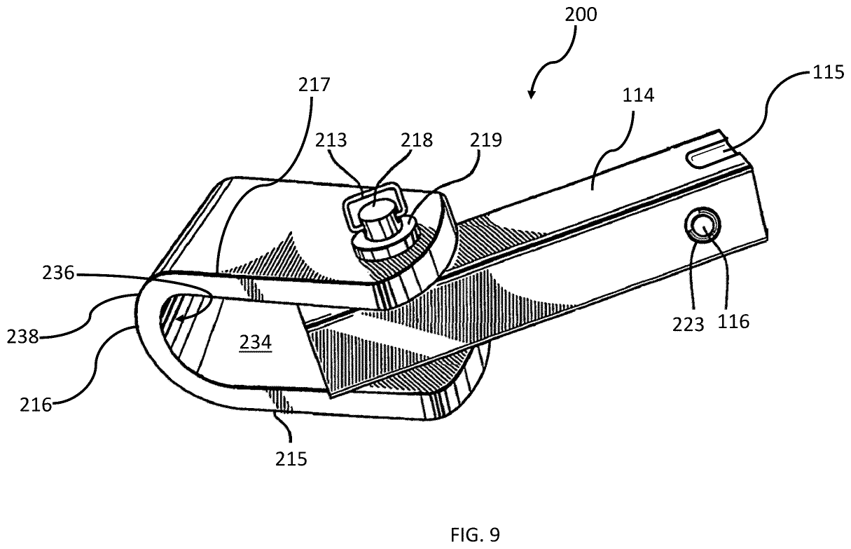

A top elevation view of an exemplary embodiment of a coupling tongue is shown in FIG. 8. Coupling tongue 114 is sized for insertion into the socket 112 of the heavy duty receiver 100, which may be attached to a vehicle. In some embodiments, the coupling tongue 114 may be square in cross-section when viewed along the A-A plane. However, it may be any of a number of other shapes in cross-section, with polygonal shapes being preferred. Coupling tongue 114 may also define an aperture 119 therethrough for receiving a hitch pin to operatively couple the coupling togue 114 to a towing member, and an opening 116 (shown in FIG. 9) for receiving a coupling pin. Coupling tongue 114 may be a solid construction of metal, or another material of sufficient strength. Coupling tongue 114 is preferably made of steel and more preferably made of aluminum.

As described above, coupling tongue 114 comprises at least one keyway 115. The at least one keyway 115 may be a slot, groove, channel, notch, cut, or any suitable surface depression sized and configured to receive the at least one protrusion 150 so that the coupling tongue 114 can be operably received into the socket 112 of the heavy duty receiver 100. By “operably received” it is meant that the coupling tongue 114 can be inserted into the heavy duty receiver 100 and securely connected thereto by insertion of a coupling pin, such as the coupling pin 22, through the opening 116. Therefore, the at least one keyway 115 is of a complementary shape and in a complementary position to the at least one protrusion 150. The at least one keyway 115 is further sized and configured to not adversely compromise the strength of the hitch when a pulling force is applied. In embodiments comprising at least two protrusions, the coupling tongue 114 has at least two keyways 115, each keyway of the at least two keyways corresponding to a respective protrusion of the at least two protrusions.

The at least one keyway 115 extends along a least a portion of external surface 117 of the coupling tongue 114, from a first end 111 towards a second end 113, a suitable length for being received into the socket 112 such that the openings of passageway 120 of the heavy duty receiver 100 and the openings of the passageways of each extender 124 align with opening 116 of the tongue, to receive a coupling pin, such as coupling pin 22.

In some embodiments, the at least one keyway 115 extends across about 1/10, 1/9, ⅛, about 1/7, about ⅙, about ⅕, about ¼, about ⅓, about ½, about ⅔, or about ¾ of the external surface 117. In some embodiments, the keyway 115 may extend across substantially the entire length of the external surface 117, without interfering with aperture 119. In an embodiment, the at least one keyway 115 has a length approximately equal to a length of the top and/or bottom wall of the socket 112 that receives the coupling tongue 114. In embodiments where the at least one keyway is at least two keyways, each keyway may extend the same length or may extended different lengths. The at least one keyway 115 may be integrally formed with the coupling tongue 114 or may be formed by milling, etching, cutting, or by any other suitable means.

The present disclosure also relates to a heavy duty hitch assembly comprising a coupling tongue as disclosed herein that is suitable for being received by a heavy duty hitch receiver also described herein. FIG. 9 shows a side perspective view of an exemplary hitch assembly 200 comprising an exemplary coupling tongue according to some embodiments of the present disclosure. The hitch assembly 200 comprises coupling tongue 114 for attachment to a heavy duty receiver 100 on a vehicle, a clevis 216 pivotally attached to the coupling tongue 114 by a hitch pin 218, and an opening 234 which can receive the towing member. Coupling tongue 114 may be reversibly attached and locked to a vehicle by the insertion of the coupling tongue 114 into the socket 112 of the heavy duty receiver 100 described herein, insertion of a coupling pin through the apertures on the extender(s) 124 and the apertures 116, and by inserting a retainer 213, such as a locking clip, at one or both ends of the coupling pin.

Clevis 216 is a generally U-shaped element. As such, clevis 216 has two legs, 215 and 217, that are so placed as to overlie coupling tongue 114, on opposite sides of the coupling tongue. Therefore, legs 215 and 217 of clevis 216 are spaced so as to allow coupling tongue to be inserted into, and to pivot, therebetween. In some embodiments coupling tongue fits snugly between legs 215 and 217, to permit very little play between legs 215 and 217. In other embodiments, the fit is not as snug and there is more play of coupling tongue 114 between legs 215 and 217. A snug fit between tongue 114 and legs 215 and 217 is preferred, as this will avoid significant turning or twisting of the clevis and coupling tongue, independently of one another, about the hitch pin 218.

Clevis 216 is pivotally attached and reversibly locked, to the coupling tongue 114. Axially aligned apertures (not shown) formed in legs 215 and 217 align with a corresponding aperture (119) on the coupling tongue to receive hitch pin 218 through the apertures (not shown) on clevis 216 and through the corresponding aperture on coupling tongue 114, thus interlinking clevis 216 with coupling tongue 114. The hitch pin is held in the aperture by use of retainer 213, such as a locking clip or ring, as is known in the art.

When mounted onto coupling tongue 114, clevis 216 will freely pivot about hitch pin 218, so that it may be aligned with the load direction applied to it from the towing member, when the hitch assembly 200 is in use.

Clevis 216 may be formed of a single piece of suitable solid metal bar stock, such as steel or aluminum bar stock, bent or molded into a desired shape. As such, clevis 216 is weldless and seamless, which may be desired in some applications where greater strength is required. In one embodiment, clevis 216 is formed from a solid, rectangular aluminum bar bent into the desired shape. In some embodiments clevis 216 may be formed by welding two or more pieces of suitable steel bar stock together, however the preferred embodiment is a weldless and seamless clevis 216. As is apparent from FIG. 9, a characteristic feature of clevis 216 is that in cross section it is significantly wider than it is thick, as it is made from a sheet or plate of metal. Therefore, it is flat, or planar, in cross-section. Because it is flat, or planar, in cross section, the interaction between legs 215 and 217 and the coupling tongue 114 occurs over a larger surface area than with D-rings or shackles of similar length. Further, a flat or planar clevis permits larger coupling pins to be used to pivotally couple the clevis and coupling tongue, than with D-rings or shackles of similar length.

Clevis 216 may be reinforced by increasing the thickness of the ends of clevis 216 (that is, at the end of each leg 215 and 217), in the area where hitch pin 218 will be inserted. These areas of reinforcement, which may be referred to as “wear plates”, provide extra strength and durability to a portion of clevis where a great amount of stress may be encountered. For example, in a situation where the vehicle to be towed is not in a direct line (i.e., a direct vertical and/or horizontal line) with the vehicle doing the towing, bending, or twisting forces may be applied to hitch assembly 200. This may result in severe stress on clevis 216 at the ends of the clevis in the areas where hitch pin 218 is inserted, and extra thickness in this area may avoid failure of the hitch assembly when in use.

Further, the end of coupling tongue 114 that is inserted into clevis 216 may damage the inner surface of clevis 216, with repeated use of the hitch assembly. The wear plate therefore, because of its extra thickness, provides added strength to clevis 216 in this region, and increases durability, for if the wear plate is somewhat damaged by binding of coupling tongue 114, the hitch assembly may still be used. The wear plates may be on the inside surface of the ends of clevis 216 as shown in the Figures, or on the outside (opposite) surface of clevis 216 (not shown).

As is apparent, clevis 216 may be of uniform thickness throughout, which may be easier to manufacture. However, for some applications, this added uniform thickness may add unnecessary weight. Therefore, by providing a smaller area of increased thickness (i.e., wear plates) at the ends of clevis 216, the strength and durability of a larger and heavier hitch assembly may be obtained, without adding too much weight to the total weight of the assembly.

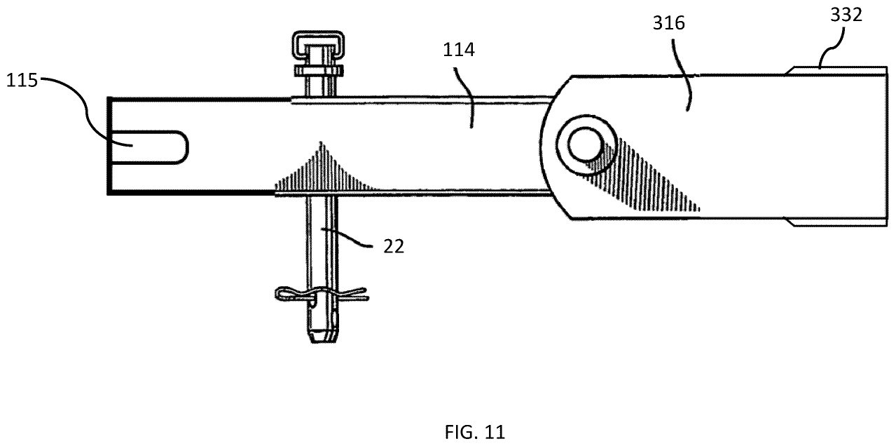

Hitch pin 218 and coupling pin 22 (shown in FIG. 11) may be made of steel that can be of varying strengths, depending on the application in which the hitch assembly will be used. For some applications, hitch pin 218 and coupling pin 22 may be made of AISI 4140 heat treated carbon and alloy steel bar, or hot rolled steel. Hitch pin 218 may be any of a number of sizes, depending on the application. Standard sizes include ½ inch, ⅝ inch and ¾ inch diameter, but other diameters may be used. Coupling pin may also be any of a number of sizes, depending on the application, with ½ inch and ⅝ inch being standard sizes. Both hitch pin 218 and coupling pin 22 may have an annular ring 219 pressed onto the pin to aid in the positioning of pins for insertion in their respective apertures. Annular ring 219 may be welded onto the pin, however this not preferred, as welding may be undesirable for some applications because it weakens the strength of the pin. Pins 218 and 22 may be coated with a corrosion resistant material, for example zinc oxide.

In one embodiment, the apertures of hitch assembly 200 are lined with a support material 223 that functions to reinforce these apertures and to decrease wear. FIG. 9 shows this support material in aperture 116, however it is understood that said support material may likewise line apertures 116 or the aperture that corresponds with apertures in the clevis 216. Particularly preferred is the use of support material in apertures of clevis 216 to provide added strength to clevis 216 in this region and to decrease wear and/or deformation of the aperture. The support material may be an annular ring inserted into the apertures, for example a steel ring such as a stainless steel ring, or a ring made of a suitably strong polymeric or synthetic material such as nylon. Stainless steel is preferred because it is corrosion resistant.

Hitch assembly 200 may be formed of suitable steel bar stock—for example AISA 1018 steel. However, other metals and materials having sufficient strength and durability may be used. In one embodiment hitch assembly 200 is constructed partially of aluminum alloy, which may provide a hitch assembly that is lighter in weight than a similarly-sized steel assembly, yet able to carry higher loads than the steel hitch assembly. In a particularly preferred embodiment, hitch assembly 200 is constructed, except for hitch pin 218, entirely out of aluminum alloy. In one embodiment, the aluminum alloy is 6061-T6511 aluminum alloy.

The towing member to be used with the hitch assembly 200 may be a flexible element disposed within opening 234. Opening 234 is an enclosed space that retains towing member, so that the towing member cannot slip out of the opening while the hitch assembly 200 is being used. The inside surface 236 of a curved portion forming a closed end 238 of clevis 216 may be ground and rounded to lessen the probability that the towing member will be damaged by abrasion from clevis 216. The towing member may be made of any of a number of materials, including synthetic and natural polymeric materials, and metal. Towing members typically include ropes, chains, cables, and towing belts, with towing belts (straps) being preferred. The hitch assembly 200 is particularly suited for use with a towing belt or other broad towing members, especially when an aluminum clevis 216 is being used, as a towing belt distributes the applied force over a larger area than would a cable or chain.

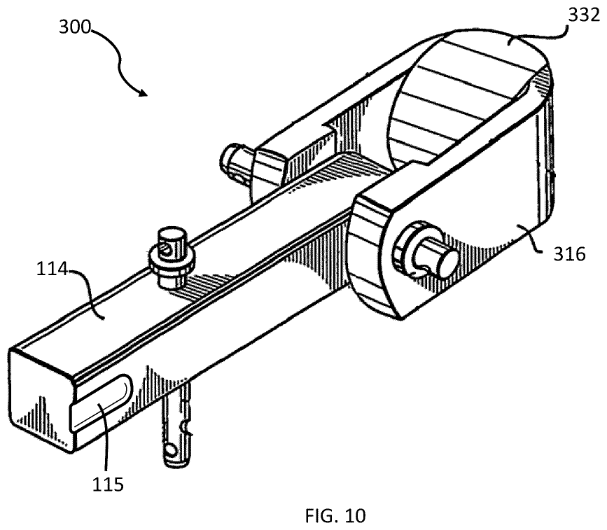

In another embodiment, shown in FIGS. 10 and 11, hitch assembly 300 may comprise a towing member adapter 332 within the opening of clevis 316. The clevis 316 is otherwise similar to the clevis 216 with like reference numbers representing like features. Towing member adapter 332 functions to spread the load experienced by the towing member over a large curved area, rather than merely at the edges where the towing member comes into contact with clevis 316. This embodiment may avoid breakage of the towing member when very heavy loads are being towed. Towing member adapter 332 may be welded to clevis 316, or it may be formed as part of a unitary construct with clevis 316. The heavy U-bend in combination with the U-shaped towing member adapter cooperate to distribute the load to the towing member by providing a more liberal radius at the location of attachment. This feature is particularly useful when the hitch assembly is being used in combination with a towing belt. Towing member adaptor may be comprised of metal, for example steel or aluminum.

While the heavy duty hitch receiver and hitch assembly have been described in conjunction with the disclosed embodiments, it will be understood that the subject matter disclosed is not intended to be limited to these embodiments. On the contrary, it is intended to cover alternative, modifications and equivalents which may be included in within the scope of the present disclosure.

1. A heavy duty hitch receiver having a coupling pin passageway for coupling the receiver to a coupling tongue with a coupling pin, the coupling pin passageway having a length and comprising a socket section and a section external to the socket, the receiver comprising:
a) a socket sized to receive the coupling tongue therein;
b) first and second axially aligned socket openings in opposing walls of the socket, the first and second openings sized for insertion of the coupling pin therethrough;
c) a first extender extending outwardly from the socket and comprising a first extender opening spaced apart a distance from, and in axial alignment with, the first socket opening, the first extender opening sized for insertion of the coupling pin therethrough;
wherein the first and second openings provide the socket section of the coupling pin passageway, and
wherein the first socket opening and the first extender opening provide the section of the coupling pin passageway external to the socket.

2. The receiver of claim 1 further comprising a second extender extending outwardly from the socket, the second extender comprising a second extender opening spaced apart a distance from, and in axial alignment with, the second socket opening, the second extender opening sized for insertion of the coupling pin therethrough;
and wherein the second socket opening and the second extender opening provide an additional section of the coupling pin passageway external to the socket.

3. The receiver of claim 1, wherein the socket is a tubular socket having a socket wall of constant thickness around the socket, and wherein the first extender and/or the second extender is attached to an outer surface of the socket wall.

4. The receiver of claim 1, wherein the socket section comprises 70% or less of the length of the coupling pin passageway.

5. The receiver of claim 1, wherein the socket is square or rectangular in cross section.

6. The receiver of claim 1, comprising at least one protrusion protruding into the socket.

7. The receiver of claim 6, wherein the at least one protrusion is positioned on a top inner surface or on a bottom inner surface of the socket.

8. A heavy duty hitch receiver comprising a coupling pin passageway having a length:
a) a tubular socket having a top wall, a bottom wall, a first side wall and a second side wall, each wall having an inner surface and an outer surface;
b) axially-aligned openings in the first side wall and the second side wall, respectively, providing a socket section of the coupling pin passageway therebetween;
c) a first extender disposed on the outer surface of the first side wall, said first extender having a first extender opening in axial alignment with the opening in the first side wall,
d) the first extender providing a first extender section of the coupling pin passageway in axial alignment with the socket section of the coupling pin passageway, and increasing the length of the coupling pin passageway by a distance between the opening in the first side wall and the first extender opening.

9. The receiver of claim 8 further comprising a second extender disposed on the outer surface of the second side wall:
a) the second extender having a second extender opening in axial alignment with the opening in the second side wall; and
b) the second extender providing a second extender section of the coupling pin passageway in axial alignment with the socket section of the coupling pin passageway, and increasing the length of the coupling pin passageway by a distance between the opening in the second side wall and the second extender opening.

10. The receiver of claim 8, wherein the walls of the tubular socket provide a square socket in cross section.

11. The receiver of claim 8, wherein the socket section of the coupling pin passageway comprises 70% or less of the length of the coupling pin passageway.

12. The receiver of claim 8 further comprising at least one protrusion protruding into the socket.

13. The receiver of claim 12 wherein the at least one protrusion is positioned on a top inner surface or on bottom inner surface of the socket.

14. A coupling tongue comprising:
a) a first end;
b) a second end;
c) a top;
d) a bottom;
e) two sides;
f) a first aperture sized to engage a coupling pin at the first end, the first aperture extending between the two sides;
g) a second aperture sized to engage a hitch pin at the second end, the second aperture extending between the top and the bottom of the coupling tongue; and
h) at least one keyway extending along at least a portion of an external surface of the coupling tongue from the first end toward the second end, the at least one keyway sized and configured for receiving a protrusion.

15. A towing assembly comprising:
a) the heavy duty hitch receiver according to claim 1; and
b) a coupling tongue comprising:
a first end;
a second end;
a top;
a bottom;
two sides;
a first aperture sized to engage a coupling pin at the first end, the first aperture extending between the two sides;
a second aperture sized to engage a hitch pin at the second end, the second aperture extending between the top and the bottom of the coupling tongue; and
at least one keyway extending along at least a portion of an external surface of the coupling tongue from the first end toward the second end, the at least one keyway sized and configured for receiving a protrusion.

16. A towing assembly comprising:
a) the heavy duty hitch receiver according to claim 8; and
b) a coupling tongue comprising:
a first end;
a second end;
a top;
a bottom;
two sides;
a first aperture sized to engage a coupling pin at the first end, the first aperture extending between the two sides;
a second aperture sized to engage a hitch pin at the second end, the second aperture extending between the top and the bottom of the coupling tongue; and
at least one keyway extending along at least a portion of an external surface of the coupling tongue from the first end toward the second end, the at least one keyway sized and configured for receiving a protrusion.
